(19) United States
(12) Patent Application Publication
(10) Pub. No.: US 2003/0193631 A1
(43) Pub. Date: Oct. 16, 2003

(54) Light guide plate apparatus and liquid crystal display using the same

(75) Inventor: Yi-Shiuan Chiou, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU OPTRONICS CORP.

(21) Appl. No.: 10/379,447

(22) Filed: Mar. 3, 2003

(30) Foreign Application Priority Data
Apr. 10, 2002 (TW) 91107223

(51) Int. Cl. G02F 1/1335

(52) U.S. Cl. 349/65

(57) ABSTRACT

A light guide plate apparatus and liquid crystal display using the same. The apparatus comprises a light guide plate and a light source, wherein the light guide plate includes an incident face, a reflection face, and a departure face. The reflection face meets the incident face at an acute angle and has a normal line and a critical angle θₙ of a total reflection. The departure face meets the incident face at an obtuse angle. The incident face meets the normal line of the reflection face at an angle θ. The light source projects a beam of light to the incident face at a radiation angle which is less than or equal to a predetermined value Φ, wherein θ=90°−Φ−θₙ. The apparatus, when applied to a liquid crystal display, is disposed in such a way that the beam of light propagating out from the departure face enters the liquid crystal display panel.

### BACKGROUND OF THE INVENTION

1. Field of the Invention

The present invention relates in general to a light guide plate for a liquid crystal display (LCD). In particular, the present invention relates to a light guide plate, in which the incident face disposed in the vicinity of the light source forms an acute angle with the departure face of the light guide plate and forms an obtuse angle with the reflection face of the light guide plate.

2. Description of the Prior Art

A conventional liquid crystal display (LCD) is shown in FIG. 1. The conventional LCD comprises a light guide plate 1 including an incident face 1a, a departure face 1b, and a reflection face 1c. The conventional LCD further includes a light source 2 disposed in the vicinity of the incident face 1a, a diffusing means 3 disposed on top of the departure face 1b, a reflection sheet 4 and a LCD panel 5 disposed on top of the reflection face 1c. The incident face 1a meets the departure face 1b and the reflection face 1c respectively at a perpendicular angle.

A beam of light is emitted from the light source 2, and enters the light guide plate 1. In the light guide plate 1, the light is reflected into the diffusing means 3. Some light departing the light guide plate 1 is reflected by the reflection sheet 4 and re-enters diffusing means 3. Before entering the LCD panel 5, the light evenly passes through the diffusing means 3.

In the conventional LCD, in order to increase the brightness of the LCD, the light intensity of the light source or the aperture ratio of the LCD panel is increased. However, the increase in light intensity of light source raises the amount of heat and the quality of LCD is also affected. In addition, the aperture ratio can not be easily increased.

### SUMMARY OF THE INVENTION

An object of the present invention is to provide a light guide plate that increases the area of incident face, and further increases the intensity of light beams into the light guide plate and the luminance of the liquid crystal display.

In one aspect of the present invention, the incident face and departure face of the light guide plate cross at an acute angle, and the incident face and reflection face cross at an obtuse angle.

In another aspect of the present invention, the area of the incident face is increased, and thus the amount of light from the light source into the light guide plate is increased.

The present invention also provides a liquid crystal display comprising a LCD panel, a diffusing means, a light guide plate, a light source, and a reflection sheet.

### BRIEF DESCRIPTION OF THE DRAWINGS

The present invention can be more fully understood by reading the subsequent detailed description in conjunction with the examples and references made to the accompanying drawings, wherein:

FIG. 1 is a perspective view showing a conventional liquid crystal display;

FIG. 2 shows a light guide plate according to the present invention; and

FIG. 3 is a perspective view showing a liquid crystal display with a light guide plate according to the present invention.

### DETAILED DESCRIPTION OF THE INVENTION

FIG. 2 depicts a light guide plate for a liquid crystal display of the present invention. The light guide plate 210 shown in FIG. 2 comprises a departure face 212, a reflection face 211, and an incident face 213. The departure face 212 is provided in the vicinity of a liquid crystal display panel (not shown). The reflection face 211 is on one side of the reflection sheet (not shown). The incident face 213 is oriented with respect to the departure face 212 at a first angle θ₁ and with respect to the reflection face 211 at a second angle θ₂. The first angle θ₁ is an acute angle, and the second angle θ₂ is an obtuse angle.

The light guide plate is commonly made of acrylic. In general, the refractive index of a light guide plate is 1.5. According to Snell's Law, the critical angle θₙ of total internal reflection produced from the beam of light at the reflection face 211 is approximately 42.15 degrees. That is, for any incident angle greater than the critical angle of 42.15 degrees, all the light is totally reflected from the face.

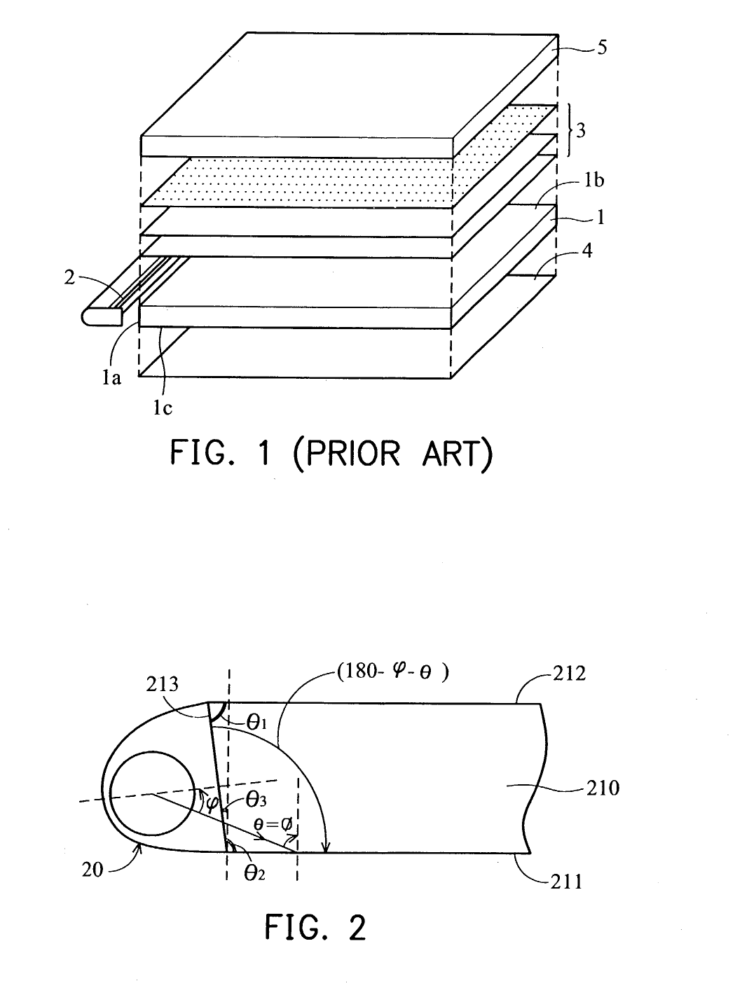

In the embodiment of the present invention, the maximum radiation angle Φ of the light source is 42 degrees. In FIG. 1 (the conventional LCD), after a beam of light from the light source 2 passes the incident face 1a and enters the light guide plate 1, the beam enters the reflection face 1c at 48 degrees, which is the incident angle Φ(=90°−Φ). However, as long as the incident angle is greater than the critical angle θ=42.15, all of the light is totally reflected. The difference between the incident angle Φ and the critical angle of total reflection θ is 5.85 degrees. Thus, in the embodiment of the present invention, the angle between the reflection face 211 and the incidence face 213 is carefully constructed to be 95.85 degrees, which is calculated from 90°+90°−Φ−θ. As a result, the beam of light from the light source 20 enters the reflection face 211 at the incident angle approximately 42.15 degrees, as shown in FIG. 2. Moreover, when the thickness of the light guide plate of the present invention is identical to that of a conventional light guide plate, the area of the incident face 213 contacting the light guide plate will be larger than that of the conventional face. At the same time, because the beam of light is totally reflected by the light guide plate 210 of the present invention, the brightness of the LCD is greatly increased.

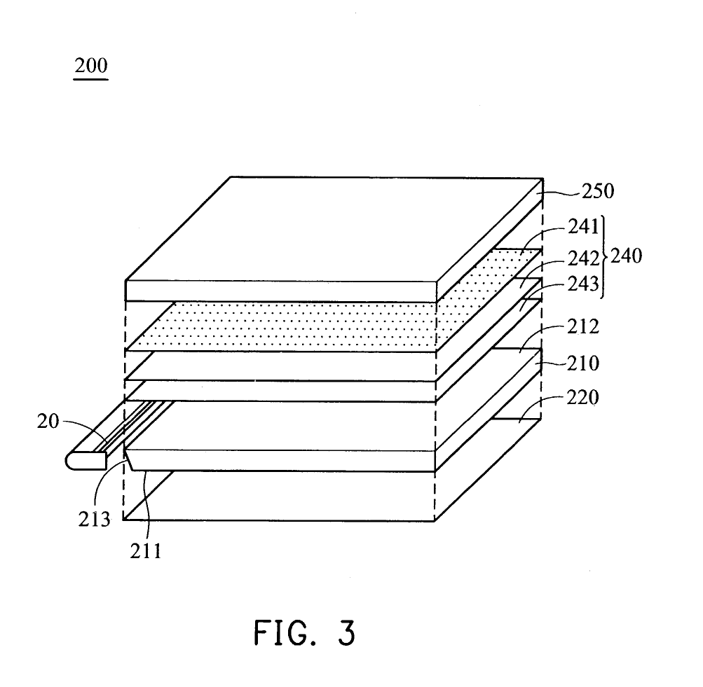

FIG. 3 shows a liquid crystal display with a light guide plate according to the present invention. As shown in FIG. 3, a liquid crystal display 200 comprises a liquid crystal display (LCD) panel 250, a light guide plate 210, a reflection sheet 220, and a light source 20. A diffusing means 240 is disposed between the LCD panel 250 and the light guide plate 210. The light guide plate 210 further comprises a light departure face 211, a reflection face 212 and an incident face 213. The departure face 211 is provided in the vicinity of the LCD panel 250. The reflection face 212 is disposed on the top of the reflection sheet 220. The incident face 213 is disposed to face the light source 20. The incident face 213 is oriented with respect to the departure face 212 at a first angle θ₁, which is an acute angle, and with respect to the reflection face 211 at a second angle θ₂, which is an obtuse angle. Furthermore, the reflection sheet 220 allows the beam of light to reflect from the reflection face 211 and propagate to the light guide plate 210.

As the area of incident face is larger than that of the conventional face, a greater amount of light produced by the light source 20 enters the light guide plate 210. The beam entering the light guide plate 210 illuminates the LCD panel 250 by evenly passing through the light guide plate 210, the reflection sheet 220, and the diffusing means 240, respectively. Thus, the intensity of light emitted from the LCD panel 250 is increased.

In the embodiment, the above-mentioned diffusing means 240 is disposed above the light guide plate 210 and below the LCD panel 250. The diffusing means comprises a diffusing sheet 241, a prism sheet 242, and a protecting film 243, respectively from top to bottom. The protecting film 243 is disposed in the vicinity of the departure face 212 of the light guide plate 210. Also, the diffusing sheet 241 is disposed below the LCD panel 250.

While the invention has been described by way of example and in terms of the preferred embodiments, it is to be understood that the invention is not limited to the disclosed embodiments. It is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for liquid crystal display, comprising:
a light guide plate including:
an incident face;
a reflection face meeting the incident face at an acute angle, having a normal line and a critical angle θₙ of a total reflection, wherein the incident face meets the normal line of the reflection face at an angle θ; and
a departure face meeting the incident face at an obtuse angle; and
a light source projecting a beam of light to the incident face at a radiation angle which is less than or equal to a predetermined value Φ, wherein θ=90°−Φ−θₙ, so that the beam of light propagates through the incident face into the light guide plate, is totally reflected from the reflection face and propagates out from the departure face.

2. An apparatus for liquid crystal display as claimed in claim 1, further comprising a reflection sheet in contact with the reflection face.

3. An apparatus for liquid crystal display as claimed in claim 1, further comprising a diffusing means disposed between the liquid crystal panel and the light guide plate.

4. An apparatus for liquid crystal display as claimed in claim 1, wherein the diffusing means includes a diffusing sheet, a prism sheet, and a protecting film, located on the light guide plate, and the prism sheet is sandwiched between the diffusing sheet and the protecting film.

5. A liquid crystal display comprising:
a light guide plate including:
an incident face;
a reflection face meeting the incident face at an acute angle, having a normal line and a critical angle θₙ, of a total reflection, wherein the incident face meets the normal line of the reflection face at an angle θ; and
a departure face meeting the incident face at an obtuse angle;
a light source projecting a beam of light to the incident face at a radiation angle which is less than or equal to a predetermined value Φ, wherein θ=90°−θₙ, so that the beam of light propagates through the incident face into the light guide plate, is reflected from the reflection face and propagates out from the departure face; and
a liquid crystal display panel disposed in such a way that the beam of light propagating out from the departure face enters the liquid crystal display panel.

6. A liquid crystal display as claimed in claim 5, further comprising a reflection sheet in contact with the reflection face.

7. A liquid crystal display as claimed in claim 5, further comprising a diffusing means disposed between the liquid crystal panel and the light guide plate.

8. A liquid crystal display as claimed in claim 5, wherein the diffusing means includes a diffusing sheet, a prism sheet, and a protecting film, located on the light guide plate, and the prism sheet is sandwiched between the diffusing sheet and the protecting film.
